(19) United States
(12) Patent Application Publication
(10) Pub. No.: US 2006/0176944 A1
(43) Pub. Date: Aug. 10, 2006

(54) Synthesizer design for network testing device

(75) Inventor: Mark G. Barmettler, Cedar Hill, TX (US)

Correspondence Address: CONLEY ROSE, P.C., 5700 GRANITE PARKWAY, SUITE 330, PLANO, TX, 75024, US

(73) Assignee: AVO Multi-Amp Corporation d/b/a Megger

(21) Appl. No.: 11/054,985

(22) Filed: Feb. 10, 2005

(51) Int. Cl. H04B 17/00

(52) U.S. Cl. 375/226

(57) ABSTRACT

A system for generating two signals whose frequencies remain a desired difference from each other while the frequencies for both of the electromagnetic signals vary through multiple ranges of output frequencies. The system includes first, second, and third tunable synthesizers, and a first and second mixers. The first tunable synthesizer produces signals varied through a range of frequencies, while the second and third a first and second fixed signals each having a first frequency. The first mixer receives the signals from the first and second tunable synthesizers, combines the signals to generate a first set of output signals having a first range of output frequencies. The second mixer receives the signals from the first and third tunable synthesizers, combines the signals to generate a second set of output signals having a second range of output frequencies, the first and second range of output frequencies differing by a desired difference.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

This invention relates in general to the field of devices for the generation of electromagnetic signals and more specifically, but not by way of limitation, to a system and method for generating two electromagnetic signals that maintain a constant difference in frequency while both signals are varied over a broad frequency range.

### BACKGROUND OF THE INVENTION

It is sometimes desirable to generate two electromagnetic signals where the difference in frequency between the two signals remains constant while the actual frequencies of the signals are varied over a range of frequencies. A traditional method of generating such signals is through the use of two separate signal generation devices such as phase-locked loops. One of the devices can be set to generate a signal with a particular frequency and the other device can be set to generate a signal with a frequency a particular amount above or below that of the first device. When the frequency of the first device is changed, the frequency of the second device is changed by the same amount so that the difference in the frequencies of the devices remains constant.

A design such as this has several drawbacks. First, this type of arrangement can be expensive. Two separate phase-locked loops or other complex frequency generation devices are required, each of which can be costly. Commercial, off-the-shelf devices that can be varied over a broad range of frequencies (e.g., 1 MHz to 1 GHz) can be particularly expensive.

Also, an arrangement such as this can be error-prone. A separate device or other means is typically needed to ensure that the frequency difference between the two signal generation devices remains constant. If this separate device does not perform properly, the frequency difference in the outputs of the two signal generation devices can be outside the acceptable range.

### SUMMARY OF THE INVENTION

According to one embodiment, a system for generating two signals whose frequencies remain a desired difference from each other while the frequencies for both of the electromagnetic signals vary through multiple ranges of output frequencies is provided. The system includes first, second, and third tunable synthesizers, the first tunable synthesizer produces variable signals varied through a range of frequencies to produce a first set of variable signals. The second tunable synthesizer that produces a first fixed signal having a first frequency. The third tunable synthesizer that produces a second fixed signal having a second frequency. The second frequency of the second fixed signal differs from the first frequency of the first fixed signal by an amount equal to the desired difference in frequency between the two sets of output signals. The system also includes a first and second mixers. The first mixer is operable to receive the first set of variable signals from the first tunable synthesizer and the first fixed signal from the second tunable synthesizer, the first mixer further operable to combine the first fixed signal with each variable signal of the first set of variable signals to generate a first set of output signals having a first range of output frequencies. The second mixer is operable to receive the first set of variable signals from the first tunable synthesizer and the second fixed signal from the third tunable synthesizer, the first mixer further operable to combine the second fixed signal with each variable signal of the first set of variable signals to generate a second set of output signals having a second range of output frequencies, the first and second range of output frequencies differing by the desired difference.

In one embodiment, a device for testing the cabling of a computing network is provided. The device includes a first mixer that injects a set of test signals having varied frequencies into the cabling of the network. The device includes a second mixer that produces a set of local oscillator signals each of which differs by a constant amount in frequency from the frequency of an associated one of the set of test signals. The device includes a first, second, and third synthesizers. The first synthesizer directs a set of signals with a range of frequencies into the first mixer and the second mixer. The second synthesizer directs a signal having a fixed frequency into the first mixer, the signal from the second synthesizer and the set of signals from the first synthesizer superimposed in the first mixer to produce the set of test signals. The third synthesizer that directs a signal having a fixed frequency into the second mixer, the signal from the third synthesizer and the set of signals from the first synthesizer superimposed in the second mixer to produce the set of local oscillator signals, wherein the fixed frequency of the signal from the third synthesizer differs by the constant amount from the fixed frequency of the signal from the second synthesizer.

Another alternative embodiment provides a method for generating electromagnetic signals with multiple ranges of frequencies. The method comprises varying a frequency of a signal from a first synthesizer through a range of frequencies, and setting a frequency of a signal from a second tunable synthesizer. The method includes setting a frequency of a signal from a third tunable synthesizer, the frequencies of the signals of the first and second tunable synthesizers set a distance apart. The method provides for directing the signals from the first synthesizer and second tunable synthesizer into a first mixer where the signals are combined to generate a first range of output signals whose frequencies are the differences in the frequencies of the signals from the first synthesizer and second tunable synthesizer. The method includes directing the signals from the first synthesizer and third tunable synthesizer into a second mixer where the signals are combined to generate second range of output signals whose frequencies are the differences in the frequencies of the signals from the first synthesizer and third tunable synthesizer. The frequencies of each corresponding signal of first and second range of output signals are provided the distance apart. The method further provides for resetting the frequency of the signal from the second tunable synthesizer so that when the signal from the first synthesizer having the frequency range is provided to be combined in the first mixer with the signal from the second tunable synthesizer. A third range of signals is generated whose frequencies are approximately contiguous with the frequencies of the signals in the first range of output signals.

These and other features and advantages will be more clearly understood from the following detailed description taken in conjunction with the accompanying drawings and claims.

### BRIEF DESCRIPTION OF THE DRAWINGS

FIG. 1 illustrates an arrangement of synthesizers and mixers, according to an embodiment of the invention, having a first range of output frequencies.

FIG. 2 illustrates an arrangement of synthesizers and mixers, according to another embodiment of the invention, having a second range of output frequencies.

FIG. 3 illustrates an arrangement of synthesizers and mixers, according to another embodiment of the invention, having a third range of output frequencies.

FIG. 4 illustrates an arrangement of synthesizers and mixers, according to another embodiment of the invention, having a fourth range of output frequencies.

FIG. 5 illustrates an arrangement of synthesizers and mixers, according to another embodiment of the invention, having a fifth range of output frequencies.

FIG. 6 illustrates an exemplary system for testing computing networks.

FIG. 7 illustrates a system for testing computing networks according to one embodiment of the invention.

FIG. 8 illustrates a system for testing computing networks according to another alternative embodiment of the invention.

For a more complete understanding of the presentation and the advantages thereof, reference is now made to the following brief description, taken in connection with the accompanying drawings and detailed description, wherein like reference numerals represent like parts.

### DETAILED DESCRIPTION OF THE PREFERRED EMBODIMENTS

It should be understood at the outset that although an exemplary implementation of one embodiment of the present invention is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

In an embodiment of the method and system described herein, three signal generation devices are used to create two electromagnetic signals whose frequencies remain a constant distance apart while the frequencies are varied through a broad range. This wide band tuning is achieved with signal generation devices, hereinafter referred to as synthesizers, that have a relatively narrow band of tuning.

The outputs of the synthesizers are directed into two mixers, also known as down converters, and the outputs of these mixers are the signals with the constant frequency difference. A particular group of settings for the output frequencies of the synthesizers produces a particular range of output frequencies from the mixers. Multiple groups of synthesizer frequencies can produce multiple ranges of mixer output frequencies.

Careful selection of the synthesizer output frequencies can ensure that the various ranges of the mixer output frequencies are contiguous. That is, the high end of a first mixer output frequency range can be nearly equal to the low end of a second mixer output frequency range. The high end of the second frequency range can be nearly equal to the low end of a third frequency range, and so on. In this manner, a very broad range of contiguous or overlapping mixer output frequencies can be created through small adjustments to the synthesizer output frequencies.

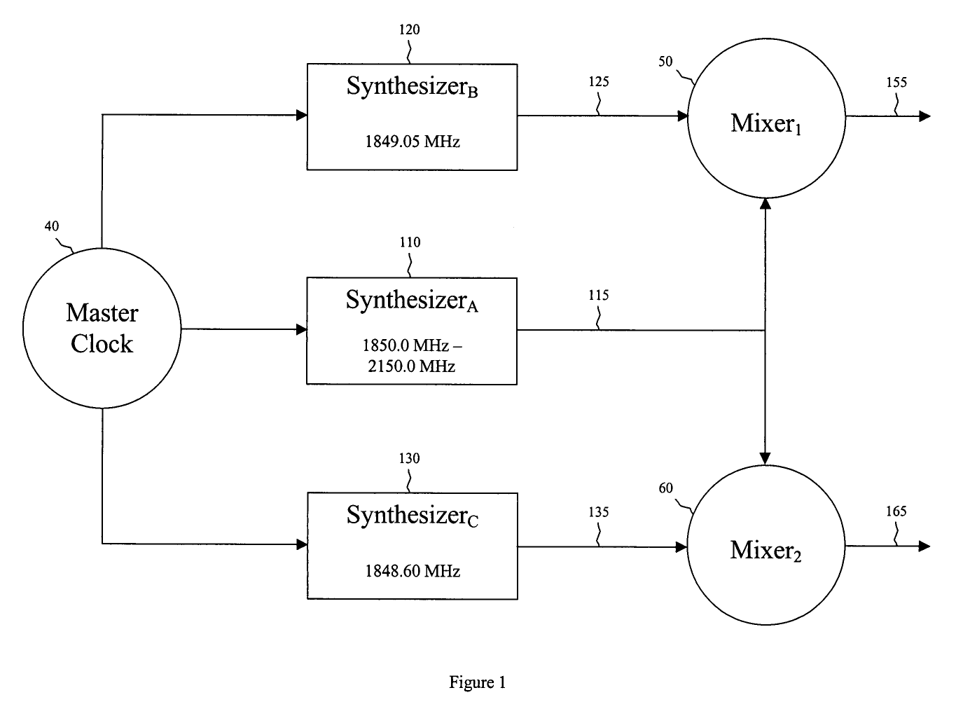

An embodiment of a system that employs such a configuration of synthesizers and mixers is shown in FIGS. 1 through 5. In this embodiment, the output frequencies of the mixers vary from approximately 1 MHz to approximately 1 GHz and the difference between the output frequencies is maintained at 450 kHz. In other embodiments, other output frequency ranges and other frequency differences could be used.

FIG. 1 depicts a configuration that produces mixer output frequencies in a range of approximately 1 MHz to approximately 300 MHz. A master clock 40, three synthesizers 110, 120, and 130, and two mixers 50 and 60 are present. The master clock 40, a standard, off-the-shelf oscillator of a type that is well known to those of skill in the art, creates a constant-frequency sinusoidal electromagnetic wave. The output of the master clock 40 is fed into synthesizer_{A} 110, synthesizer_{B} 120, and synthesizer_{C} 130.

Synthesizer_{A} 110, synthesizer_{B} 120, and synthesizer_{C} 130 are standard, off-the-shelf items, such as phase-locked loops, that produce an output signal with a stable frequency. The synthesizers 110, 120, and 130 can accept a signal from the master clock 40 and convert the signal into a signal with a different frequency. In the embodiment of FIG. 1, synthesizer_{A} 110, synthesizer_{B} 120, and synthesizer_{C} 130 are tunable synthesizers. That is, each synthesizer 110, 120, and 130 has a range of available output frequencies from which a user can select a desired output frequency. The synthesizer 110, 120, and 130 will produce a stable output signal at the chosen frequency.

In the embodiment of FIG. 1, synthesizer_{B} 120 is held at a constant frequency of 1849.05 MHz and synthesizer_{C} 130 is held at a constant frequency of 1848.60 MHz. It can be seen that the difference in frequency between synthesizer_{B} 120 and synthesizer_{C} 130 is 450 kHz, that is, the desired difference between the outputs of the mixers. The output of synthesizer_{A} 110 can be varied by a user in a range from 1850.0 MHz to 2150.0 MHz.

The output 115 of synthesizer_{A} 110 and the output 125 of synthesizer_{B} 120 are fed into mixer₁ 50 and the output 115 of synthesizer_{A} 110 and the output 135 of synthesizer_{C} 130 are fed into mixer₂ 60. As with the master clock 40 and the synthesizers 110, 120, and 130, the mixers 50 and 60 can be standard, off-the-shelf items. Mixer₁ 50 and mixer₂ 60 superimpose their input signals to create output signals 155 and 165, respectively. As is well known in the art, when two signals with different frequencies are superimposed, the result is a signal with a frequency that is the difference between the frequencies of the two original signals.

Thus, when synthesizer_{A} 110 is set at the lowest frequency of its range, 1850.0 MHz, and the output 115 of synthesizer_{A} 110 and the output 125 of synthesizer_{B} 120 are mixed in mixer₁ 50, the output 155 from mixer₁ 50 will have a frequency of 1850.0 MHz minus 1849.05 MHz, or 0.95 MHz. Similarly, when synthesizer_{A} 110 is set at the lowest frequency of its range, and the output 115 of synthesizer_{A} 110 and the output 135 of synthesizer_{C} 130 are mixed in mixer₂ 60, the output 165 from mixer₂ 60 will have a frequency of 1850.0 MHz minus 1848.60 MHz, or 1.40 MHz. It can be seen that the difference in frequency between the output 155 of mixer₁ 50 and the output 165 of mixer₂ 60 is 1.40 MHz minus 0.95 MHz or 450 kHz, which is the desired difference between the two signals.

If the frequency of the output 115 of synthesizer_{A} 110 is adjusted upward, for example by 200 kHz to 1850.2 MHz, a similar outcome occurs. When the output 115 of synthesizer_{A} 110 and the output 125 of synthesizer_{B} 120 are mixed, the resulting signal has a frequency of 1850.2 MHz minus 1849.05 MHz, or 1.15 MHz. When the output 115 of synthesizer_{A} 110 and the output 135 of synthesizer_{C} 130 are mixed, the resulting signal has a frequency of 1850.2 MHz minus 1848.60 MHz, or 1.6 MHz. Once again, it can be seen that the difference in frequency between the output 155 of mixer₁ 50 and the output 165 of mixer₂ 60 is 450 kHz.

Similar results will occur as synthesizer_{A} 110 is adjusted throughout its frequency range of 1850.0 MHz to 2150.0 MHz. For example, when synthesizer_{A} 110 is at its highest possible frequency, 2150.0 MHz, the output 155 of mixer₁ 50 is 300.95 MHz (2150.0 MHz−1849.05 MHz) and the output 165 of mixer₂ 60 is 301.4 MHz (2150.0 MHz−1848.60 MHz), once again giving a difference of 450 kHz.

Thus, as synthesizer_{A} 110 is varied throughout its frequency range, the output 155 of mixer₁ 50 varies from 0.95 MHz to 300.95 MHz and the output 165 of mixer₂ 60 varies from 1.4 MHz to 301.4 MHz. Two signals are created that range in frequency from approximately 1 MHz to approximately 300 MHz and have a constant difference in frequency of 450 kHz.

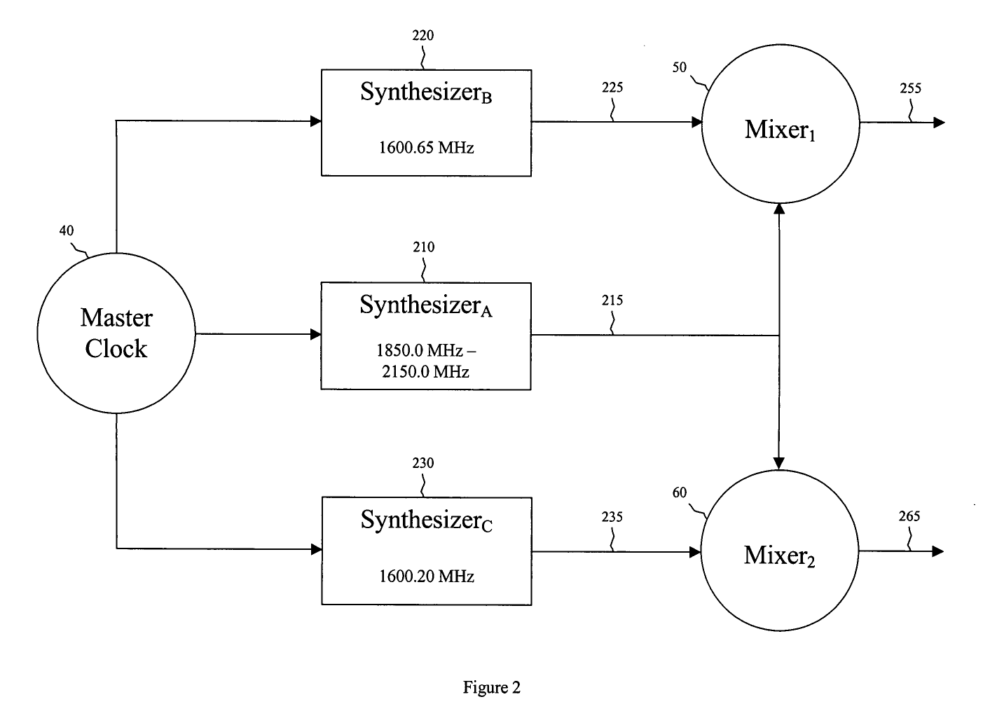

If two signals with a different range of frequencies are desired, the frequencies of the outputs 125 and 135 of synthesizer_{B} 120 and synthesizer_{C} 130 can be set at different values. An arrangement such as this is shown in FIG. 2. As in FIG. 1, a master clock 40, three synthesizers 210, 220, and 230, and two mixers 50 and 60 are present. The synthesizers 210, 220, and 230 in FIG. 2 may be the same physical devices as the synthesizers 110, 120, and 130 in FIG. 1, but are given different reference numbers in FIG. 2 to emphasize the fact that synthesizer_{B} 220 and synthesizer_{C} 230 in FIG. 2 may be set at different frequencies than synthesizer_{B} 120 and synthesizer_{C} 130 in FIG. 1. Specifically in this embodiment, synthesizer_{B} 220 is set to produce an output signal with a frequency of 1600.65 MHz and synthesizer_{C} 230 is set to produce an output signal with a frequency of 1600.20 MHz, again creating a frequency difference of 450 kHz.

As in FIG. 1, synthesizer_{A} 210 is user-adjustable to produce signals in the range of 1850.0 MHz to 2150.0 MHz. When the output frequencies are determined as described above, it can be seen that, as synthesizer_{A} 210 is adjusted throughout its range, the output 255 of mixer₁ 50 will range from 249.35 MHz to 549.35 MHz and the output 265 of mixer₂ 60 will range from 249.80 MHz to 549.80 MHz. A constant difference in frequency of 450 kHz will again be maintained between the two outputs 255 and 265 throughout these ranges.

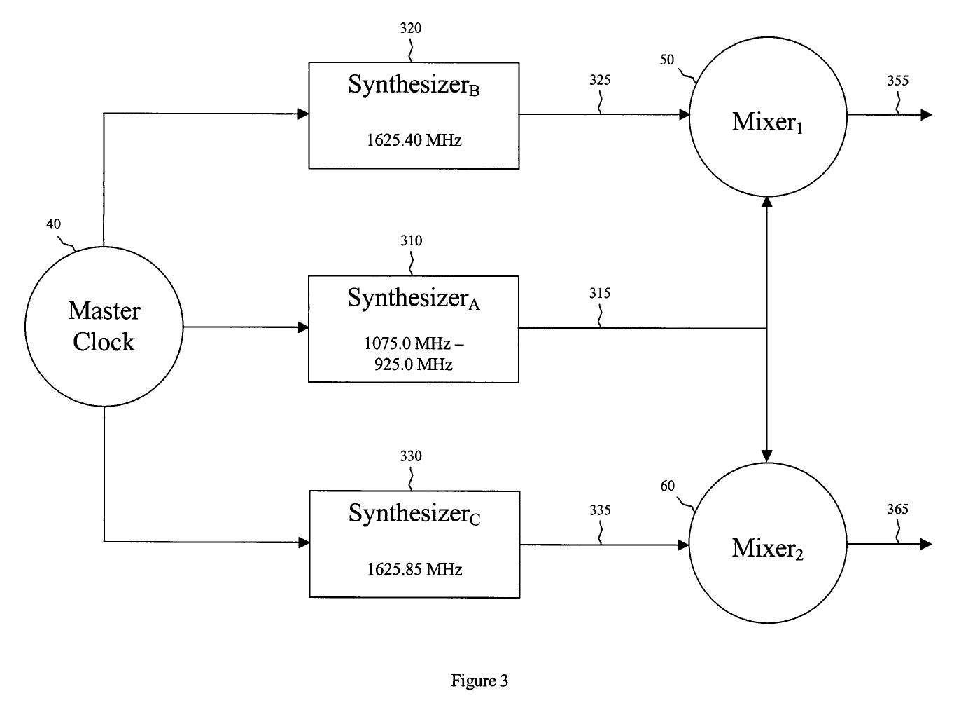

In the scenario depicted in FIG. 1, the outputs 155 and 165 of mixer₁ 50 and mixer₂ 60 range between approximately 1 MHz and 300 MHz. In the scenario depicted in FIG. 2, the outputs 255 and 265 of mixer₁ 50 and mixer₂ 60 range between approximately 250 MHz and 550 MHz. Since the same physical components are used in both scenarios, these components can provide outputs with a continuous range of approximately 1 MHz to approximately 550 MHz. Further adjustments in the frequencies of the outputs of the synthesizers can produce outputs from the mixers with different ranges. An example of such an adjustment is illustrated in FIG. 3.

In this arrangement, synthesizer_{A} 110 has standard internal circuitry that allows it to divide the frequencies of the signals it produces by a factor of two. That is, instead of the frequency range of 1850.0 MHz to 2150.0 MHz shown for synthesizer_{A} in FIGS. 1 and 2, the output of synthesizer_{A} 310 in FIG. 3 is adjusted to a frequency range of 1075.0 MHz to 925.0 MHz. Synthesizer_{B} 320 and synthesizer_{C} 330 are held at constant frequencies of 1625.40 MHz and 1625.85 MHz, respectively, once again creating a frequency difference between them of 450 kHz.

If the output frequencies for this arrangement are determined in the manner described above, it can be seen that a different frequency range is produced. When synthesizer_{A} 310 is set at its highest frequency, 1075.0 MHz, and the output 315 of synthesizer_{A} 310 is mixed with the output 325 of synthesizer_{B} 320 in mixer₁ 50, the output 355 of mixer₁ 50 has a frequency of 550.4 MHz (1625.40 MHz−1075.0 MHz). When synthesizer_{A} 310 is set at its highest frequency and the output 315 of synthesizer_{A} 310 is mixed with the output 335 of synthesizer_{C} 330 in mixer₂ 60, the output 365 of mixer₂ 60 has a frequency of 550.85 MHz (1625.85 MHz−1075.0 MHz).

As synthesizer_{A} 310 is adjusted from 1075.0 MHz to 925.0 MHz, the output frequencies for mixer₁ 50 and mixer₂ 60 increase to 700.4 MHz and 700.85 MHz, respectively. A constant difference of 450 kHz is again maintained between the frequency of the output 355 of mixer₁ 50 and the frequency of the output 365 of mixer₂ 60 while the output frequencies range between approximately 550 MHz and approximately 700 MHz.

In FIGS. 1 and 2, the frequencies of synthesizer_{B} and synthesizer_{C} are less than the frequency of synthesizer_{A}, the frequency of synthesizer_{C} is less than the frequency of synthesizer_{B}, and the frequency of synthesizer_{A} is adjusted from a minimum to a maximum. In FIG. 3, on the other hand, the frequencies of synthesizer_{B} 320 and synthesizer_{C} 330 are greater than the frequency of synthesizer_{A} 310, the frequency of synthesizer_{C} 330 is greater than the frequency of synthesizer_{B} 320, and the frequency of synthesizer_{A} 310 is adjusted from a maximum to a minimum. One of skill in the art will appreciate that these differences in relative magnitude of the frequencies are not relevant to the ultimate magnitude of the outputs of the mixers. The resulting frequency of the superimposition of two signals with different frequencies is the absolute value of the difference between the frequencies.

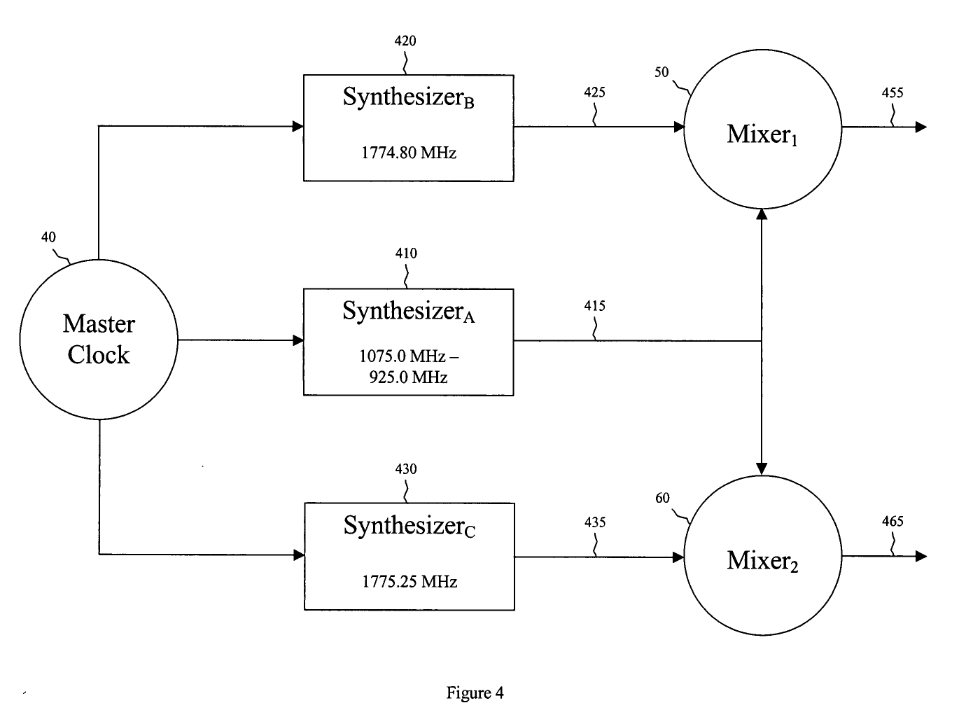

The set of frequencies selected for the synthesizers 310, 320, and 330 in FIG. 3 produce mixer outputs 355 and 365 with frequencies in a range from approximately 550 MHz to approximately 700 MHz. Different sets of frequencies for the synthesizer outputs will produce different ranges of mixer output frequencies. For example, in FIG. 4, synthesizer_{A} 410 is again varied from 1075.0 MHz to 925.0 MHz and synthesizer_{B} 420 and synthesizer_{C} 430 are held constant at 1774.80 MHz and 1775.25 MHz, respectively. When the mixer output frequencies for this arrangement are determined in the manner described above, it can be seen that the resulting outputs 455 and 465 from mixer₁ 50 and mixer₂ 60 have frequencies that range from approximately 700 MHz to approximately 850 MHz with a constant difference of 450 kHz.

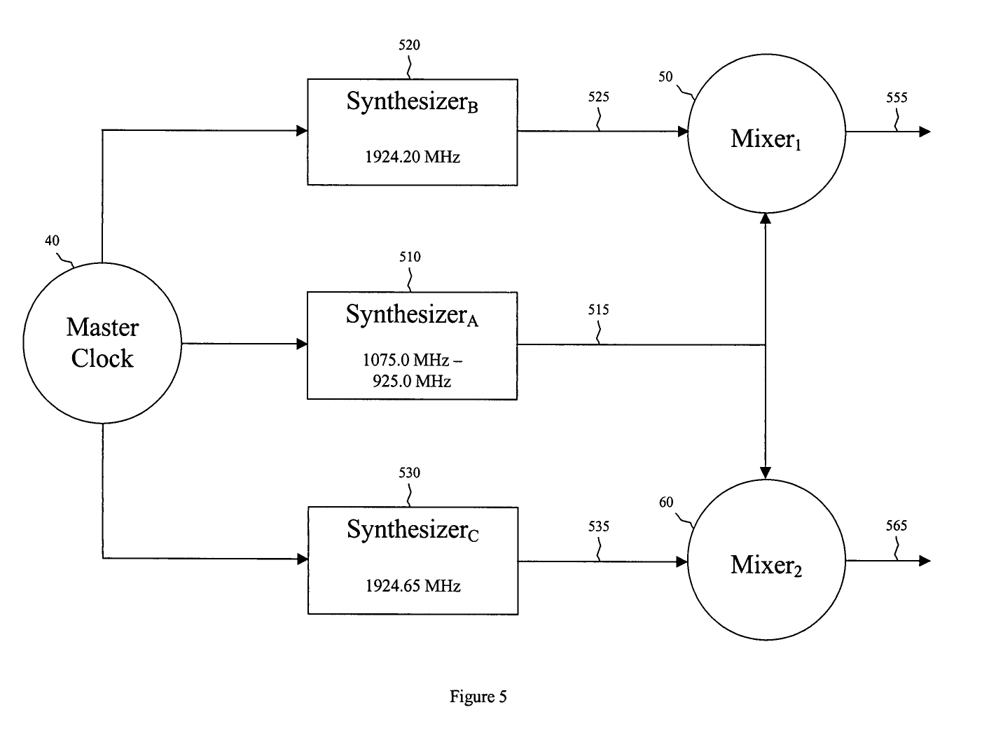

In FIG. 5, synthesizer_{B} 520 is held at 1924.20 MHz and synthesizer_{C} 530 is held at 1924.65 MHz while synthesizer_{A} 510 is varied from 1075.0 MHz to 925.0 MHz. This produces mixer outputs 555 and 565 with frequencies in a range from approximately 850 MHz to approximately 1000 MHz with a constant difference of 450 kHz.

Thus, the set of synthesizer output frequencies in FIG. 1 produced two mixer output frequencies in a range of approximately 1 MHz to approximately 300 MHz, the set of synthesizer output frequencies in FIG. 2 produced two mixer output frequencies in a range of approximately 250 MHz to approximately 550 MHz. The set of synthesizer output frequencies in FIG. 3 produced two mixer output frequencies in a range of approximately 550 MHz to 700 MHz, the set of synthesizer output frequencies in FIG. 4 produced two mixer output frequencies in a range of approximately 700 MHz to approximately 850 MHz. The set of synthesizer output frequencies in FIG. 5 produced two mixer output frequencies in a range of approximately 850 MHz to 1000 MHz. The difference between the two mixer output frequencies remained constant at 450 kHz throughout these ranges.

Selection of appropriate synthesizer output frequencies created mixer output frequency ranges that were contiguous or slightly overlapping. Since the same set of components was used to create each of these ranges of frequencies, these components can create a combined frequency range that spans each of the individual ranges. In the embodiment of FIGS. 1 through 5, the combined frequency range is approximately 1 MHz to 1 GHz. Similar procedures could be used to produce outputs in other frequency ranges.

This wide range of mixer output frequencies is achieved with only narrow adjustments in the output frequencies of the synthesizers. Synthesizer_{B} and synthesizer_{C} are adjusted in a range from approximately 1600 MHz to approximately 1950 MHz and synthesizer_{A} is adjusted in a range from approximately 1850 MHz to 2150 MHz. Frequency division can cause the output of synthesizer_{A} to be in a range of 925 MHz to 1075 MHz, but a device with a nominal frequency range of 1850 MHz to 2150 MHz can still be utilized. Synthesizers with user-adjustable frequencies in the range of 1600 to 1950 MHz and synthesizers with user-adjustable frequencies in the range of 1850 to 2150 MHz are readily available, inexpensive, off-the-shelf items. Therefore, a system that produces two output signals with a constant difference in frequency and a frequency range of approximately 1 MHz to 1 GHz can be built with inexpensive, readily available components having much narrower frequency ranges.

In more general terms, three standard, variable-frequency synthesizers and two standard mixers are configured to produce two electromagnetic signals. The output of a first synthesizer and the output of a second synthesizer are directed into a first mixer and the output of the first synthesizer and the output of a third synthesizer are directed into a second mixer. The outputs of the first and second mixers are two signals that maintain a constant difference in frequency while both signals are varied through a range of frequencies.

The frequencies of the outputs of the second and third synthesizers are held constant while the frequency of the output of the first synthesizer is varied through a range of frequencies. Therefore, the second and third synthesizers can be referred to as fixed synthesizers and the first synthesizer can be referred to as a variable synthesizer. The frequencies of the outputs of the second and third synthesizers are chosen to be different from each other so that the difference in their frequencies is equal to the desired difference in the frequencies of the mixer outputs.

When the outputs of the first and second synthesizers are combined in the first mixer, the output of the first mixer is a signal with a frequency that is the difference in the frequencies of the first and second synthesizers. When the outputs of the first and third synthesizers are combined in the second mixer, the output of the second mixer is a signal with a frequency that is the difference in the frequencies of the first and third synthesizers. The difference in the frequencies of the outputs of the first and second mixers equals the difference in the frequencies of the outputs of the second and third synthesizers.

As the frequency of the output of the first synthesizer is varied between a minimum and a maximum, the frequencies of the outputs of the mixers will also vary between a minimum and a maximum. The size of the range between the minimum and maximum output frequencies from the first synthesizer equals the size of the range between the minimum and maximum mixer output frequencies.

The actual values of the mixer output frequencies depend on the values of the synthesizer output frequencies. The minimum value of a range of output frequencies from the first mixer is the difference between the frequency of the second synthesizer and the output frequency limit of the first synthesizer that is closest to the frequency of the second synthesizer. As an example, the output frequencies of the first synthesizer might range between 2000 MHz and 3000 MHz. The minimum value of a range of output frequencies from the first mixer can be made arbitrarily small by choosing a value for the output frequency of the second synthesizer that is arbitrarily close to either of the frequency limits of the first synthesizer, 2000 MHz or 3000 MHz.

For instance, if an output frequency of 1999 MHz is selected for the second synthesizer, the minimum value of a range of output frequencies from the first mixer will be 1 MHz (2000 MHz−1999 MHz). Similarly, if an output frequency of 3001 MHz is selected for the second synthesizer, the minimum value of a range of output frequencies from the first mixer will again be 1 MHz (3001 MHz−3000 MHz).

In these examples, the maximum value of the range of output frequencies from the first mixer would be the difference between the frequency of the output of the second synthesizer and the output frequency limit of the first synthesizer that is farthest from the output frequency of the second synthesizer. That is, the maximum of the range would be 1001 MHz (either 3000 MHz−1999 MHz or 3001 MHz−2000 MHz). In other words, the maximum value of a mixer output range is equal to the minimum value of the mixer output range plus the size of the range of frequencies that the first synthesizer spans (1 MHz+1000 MHz in either case).

A different range of output frequencies from the first mixer can be produced by choosing a different value for the output frequency of the second synthesizer. Careful selection of several different output frequencies from the second synthesizer can produce multiple ranges of output frequencies from the first mixer that are contiguous or that slightly overlap. For example, a second range of frequencies might be desired from the first mixer that is contiguous with or slightly overlaps the range from the example above. That is, the second range would have a minimum frequency that is approximately equal to the maximum frequency of the range described above, 1001 MHz.

To create such a range, a frequency for the output of the second synthesizer would be chosen that is approximately 1000 MHz greater than the greater frequency chosen above or 1000 MHz less than the lower frequency chosen above for the output of the second synthesizer. That is, the amount that is added to or subtracted from the frequency chosen above for the output of the second synthesizer is approximately equal to the size of the range of output frequencies from the first mixer. In this example, the chosen frequencies would be approximately 999 MHz or approximately 4001 MHz.

With either of these frequencies for the output of the second synthesizer, the first mixer would produce an output frequency in the range from 1001 MHz to 2001 MHz when the output frequency of the first synthesizer is varied from 2000 MHz to 3000 MHz. The minimum frequency of this range would be either 2000 MHz−999 MHz or 4001 MHz−3000 MHz and the maximum frequency of this range would be either 3000 MHz−999 MHz or 4001 MHz−2000 MHz. In other words, the maximum value is again equal to the minimum value plus the size of the range of frequencies that the first synthesizer spans (1001 MHz+1000 MHz ).

The synthesizers used in a system such as this might be limited in the range of output frequencies they can produce. For example, a synthesizer whose output frequency is set at 999 MHz cannot have its output frequency decreased by 1000 MHz. When the frequency of the output of the second synthesizer approaches a limit of its range and cannot be adequately adjusted further, additional frequency ranges in the output of the first mixer can be produced by making a change in the output frequency range of the first synthesizer.

For instance, the upper and lower limits of the output frequency range of the first synthesizer might be multiplied by two, divided by two, or multiplied or divided by some other factor. Commercial, off-the-shelf synthesizers such as those that can be used in the present disclosure may contain internal circuitry that allows such frequency division or multiplication. The term “frequency division” is used herein to describe any such adjustment of frequency by an integral factor or a reciprocal of an integral factor.

Continuing the example above, frequency division could be used on the first synthesizer to adjust its frequency range from the range of 2000 MHz to 3000 MHz to the range of 4000 MHz to 6000 MHz. The frequency of the output of the second synthesizer could then be set at a value that will cause the lowest frequency of the output of the first mixer to be approximately equal to the highest frequency of the range of frequencies previously created by the first mixer.

In the example above, the greatest output frequency produced by the first mixer was 2001 MHz so the lowest frequency desired in the new frequency range to be created would also be approximately 2001 MHz. The frequency of the output of the second synthesizer could be set at a value where the difference between the lowest frequency of the first synthesizer's frequency range (4000 MHz) and the frequency of the output of the second synthesizer is equal to 2001 MHz. A frequency of 1999 MHz for the output of the second synthesizer would produce this result.

As the frequency of the output of the first synthesizer is increased from its minimum to its maximum, the frequency of the output of the first mixer would also increase from a minimum to a maximum. In this example, the frequency of the output of the first mixer would increase from 2001 MHz to 4001 MHz, where the maximum mixer output frequency is again equal to the minimum frequency plus the size of the range of frequencies produced by the first synthesizer (2001 MHz+2000 MHz).

The above discussion has focused on the frequencies selected for the outputs of the first and second synthesizers and the resulting output frequencies from the first mixer. The values chosen for the frequencies of the output of the third synthesizer depend on the desired difference between the frequencies of the two mixer outputs. For any chosen frequency of the output of the second synthesizer, the frequency of the output of the third synthesizer is selected to be greater than or less than the frequency of the output of the second synthesizer by an amount equal to the desired difference between the frequencies of the two mixer outputs.

For example, if an output frequency of 1999 MHz is selected for the second synthesizer and the desired difference between the frequencies of the two mixer outputs is 1 MHz, an output frequency of either 1998 MHz or 2000 MHz could be selected for the third synthesizer. In either case, the difference between the output frequencies of the second and third synthesizers would be the desired 1 MHz. It will be clear to one of skill in the art that the same frequency difference will appear between the outputs of the first and second mixers. An analysis similar to that described above can be performed to determine the actual values of the frequencies of the output from the second mixer. These values will differ from the frequency of the output from the first mixer by the desired amount for any value of the frequency of the output from the first mixer.

At this point, three contiguous frequency ranges, one from 1 MHz to 1001 MHz, one from 1001 MHz to 2001 MHz, and one from 2001 MHz to 4001 MHz, have been created, producing a combined frequency range of 1 MHz to 4001 MHz. The above process can be continued by further multiplying or dividing the frequency of the output of the first synthesizer and then setting the frequencies of the outputs of the second and third synthesizers to appropriate values so that multiple contiguous or overlapping frequency ranges are produced by the mixers that together span a desired combined frequency range.

Numerous variations on the procedures described above will produce similar results. One of skill in the art will recognize that the frequency of the output of the first synthesizer can be either multiplied or divided as needed, the ranges of the frequencies produced by the mixers can be contiguous or can overlap, the frequencies of the outputs of the second and third synthesizers can be either greater than or less than the frequencies of the output of the first synthesizer, the frequencies of the outputs of the second and third synthesizers can be adjusted either upward or downward as necessary, and so on.

In any variation, the frequencies of the outputs of the first and second synthesizers are chosen to produce output frequencies from the first mixer in a desired set of frequency ranges. The frequencies of the output of the third synthesizer are chosen to differ from the frequencies of the output of the second synthesizer by an amount that is equal to the desired difference in the frequencies of the outputs of the first and second mixers. Such an arrangement will produce two output signals that can be varied over a wide range of frequencies while a constant difference in frequency is maintained between the two signals.

Signals with these properties can be useful in performing tests on information system networks that include cabling, connectors, and adapters for communicating data signals. The cabling, connectors, and adapters installed in an office or other structure typically must meet certain standards to assure that the network is operable for the use of businesses in the structure. To certify network cabling, a measurement or test device may be connected at one point in the network of the structure and a second measurement device may be connected at another point in the network.

The first measurement device, for example, generates a signal that is transmitted through the network cabling and is received by the second measurement device, which analyzes the signal to evaluate the integrity of the cabling. In some instances a first measurement device may be a dual function device that is capable of supporting the roles of both test signal injection and test signal reception and analysis.

Various test signals may be employed to test the network. One test signal, for example, may comprise a constant amplitude sinusoidal wave that is swept through an appropriate frequency range. The frequency response of the network may be characterized by comparing the amplitude and phase of the signal injected by the first measurement device to the amplitude and phase of the signal received by the second measurement device at each frequency in the swept range. A decrease in amplitude or a shift in phase in the received signal can indicate a problem in the cabling, connectors, or adapters in the network.

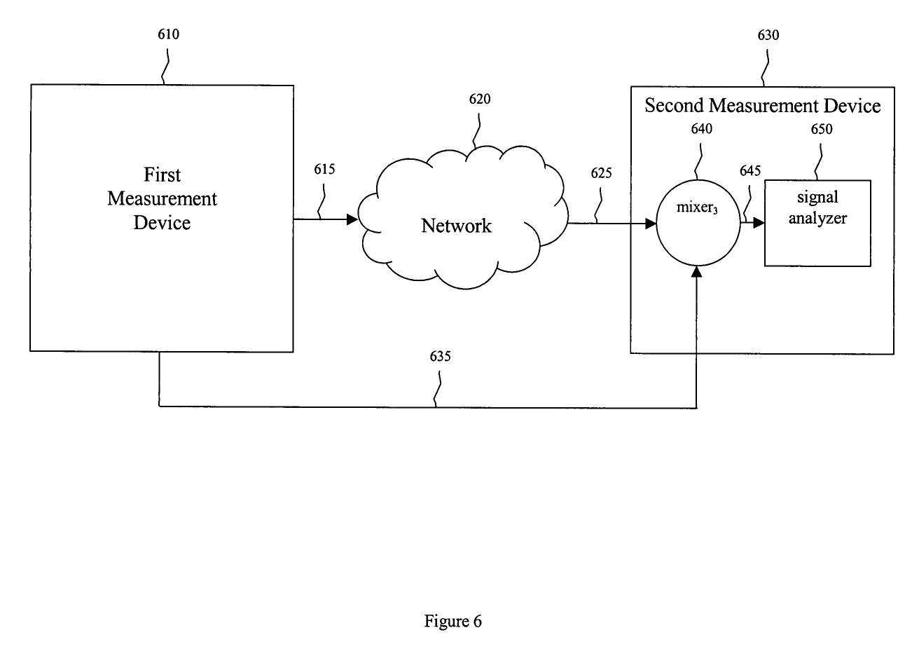

In actual practice, the received signal is typically not analyzed directly. Instead, an arrangement such as that shown in FIG. 6 might be implemented. A first measurement device 610 injects a test signal, or transmit signal, into a network 620 via output 615. The test signal passes through the network 620 and is received by a second measurement device 630 via output 625.

A second signal, commonly referred to as a local oscillator, bypasses the network 620 and travels directly from the first measurement device 610 to the second measurement device 630 via output 635. Alternatively, the local oscillator signal might pass from the first measurement device 610, through the network 620, into the second measurement device 630. In another variation, the device that generates the local oscillator signal might be located in the second measurement device 630. The local oscillator signal typically has a frequency that is maintained at a constant difference from the frequency of the test signal.

The second measurement device 630 includes a mixer₃ 640 and a signal analyzer 650. The test signal and the local oscillator signal are sent, via outputs 625 and 635 respectively, into the mixer₃ 640 where they are superimposed. The combined signal produced by mixer₃ 640 has a frequency that is the difference between the frequency of the test signal and the frequency of the local oscillator signal. This signal, commonly referred to as the intermediate frequency, is fed via output 645 into the signal analyzer 650 where it is analyzed.

If the difference between the frequency of the test signal and the frequency of the local oscillator signal is kept constant while the test signal is swept through a range of frequencies, the frequency of the signal that is fed into the signal analyzer 650 will remain constant. That is, the intermediate frequency will be the difference in the frequencies of the test signal and the local oscillator signal. A frequency of 450 kHz is commonly used in the network testing industry for this signal.

As will be understood by one of skill in the art, the intermediate frequency is a linear representation of the magnitude and phase of the test signal. Any decrease in amplitude or shift in phase that occurs in the test signal when the test signal passes through the network 620 will appear in the combined signal that is produced by the mixer₃ 640 and fed into the signal analyzer 650. Thus, the signal analyzer 650 can detect changes in the amplitude or phase of test signals of various frequencies by measuring the amplitude and phase of a signal at a single frequency. Such an arrangement greatly reduces the complexity of the signal analyzer 650 compared to a signal analyzer that can monitor multiple frequencies.

The test signal and the local oscillator signal produced by the first measurement device 610 are typically generated by two separate oscillators. When the frequency of the first oscillator is changed, the frequency of the second oscillator is changed by the same amount so that the difference in the frequencies of the oscillators remains constant. As discussed above, such a design can be expensive and error-prone.

In an embodiment of the present invention, the first measurement device 610 comprises a set of components such as those shown in FIGS. 1 through 5. That is, the outputs of mixer₁ 50 and mixer₂ 60 in FIGS. 1 through 5 can serve as the test signal and local oscillator signal that are fed into the network 620 and the second measurement device 630 in FIG. 6. The output of mixer₁ 50 can be the test signal and the output of mixer₂ 60 can be the local oscillator or vice versa. As discussed above, the frequency of the output of a first mixer 50 or 60 can be varied over a wide range (1 MHz to 1 GHz, for example) while the frequency of a second mixer 50 or 60 is maintained at a constant difference from that of the first mixer 50 or 60. In an embodiment, the frequency difference is 450 kHz but other frequency differences could be used.

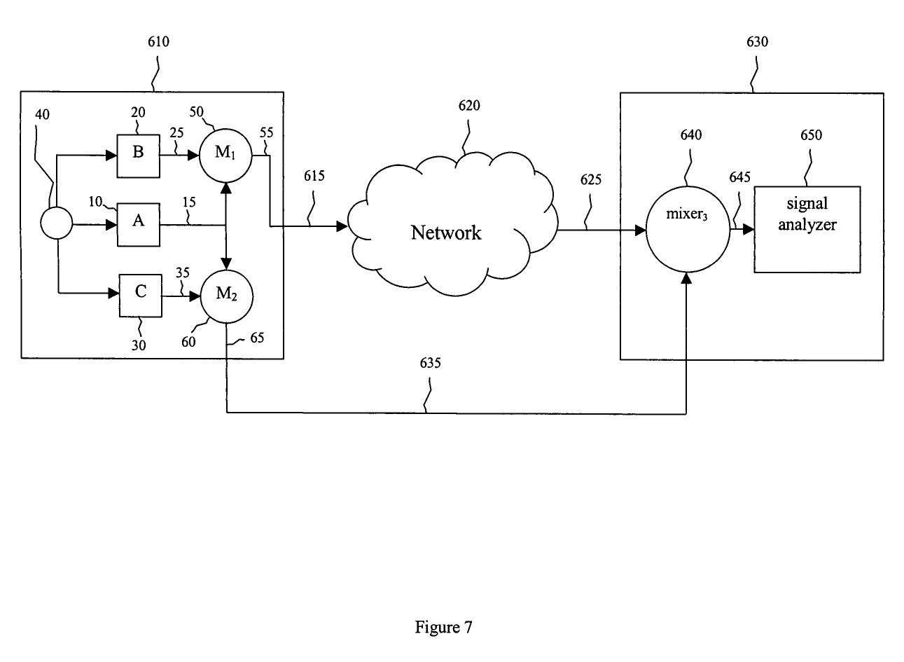

An embodiment such as this is illustrated in FIG. 7. A master clock 40, three synthesizers 10, 20, and 30, and two mixers 50 and 60 are present, similar to the arrangement shown in FIGS. 1 through 5. The output 15 of synthesizers 10 and the output 25 of synthesizer_{B} 20 are fed into mixer₁ 50. The output 15 of synthesizer_{A} 10 and the output 35 of synthesizer_{C} 30 are fed into mixer₂ 60. The output 55 of mixer₁ 50 is fed into the network 620 as a test signal. Thus, output 55 in FIG. 7 is equivalent to output 615 FIG. 6. The output 65 of mixer₂ 60 acts as a local oscillator and is fed into the mixer₃ 640 in the second measurement device 630. Thus, output 65 in FIG. 7 is equivalent to output 635 in FIG. 6. Alternatively, the output 55 of mixer₁ 50 can act as the local oscillator and the output 65 of mixer₂ 60 can act as the test signal. Mixing and analysis of the test and local oscillator signals occurs in the second measurement device 630 as described above.

As was the case with FIG. 6, the local oscillator signal can bypass the network 620 via output path 635, can pass from the first measurement device 610, through the network 620, to the second measurement device 630, or can be generated within the second measurement device 630.

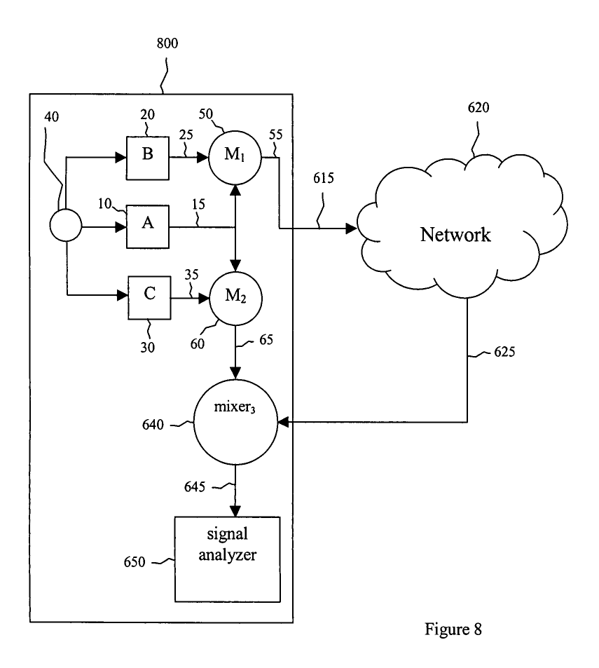

In an alternative embodiment, depicted in FIG. 8, the functions of the first measurement device and the second measurement device are combined into a single device 800. That is, device 800 comprises a master clock 40, three synthesizers 10, 20, and 30, three mixers 50, 60, and 640, and a signal analyzer 650 in the configuration shown in FIG. 8. In this case, the test signal injected by the device 800 into the network 620 follows a path 625 through the network 620 that allows the test signal to be returned to the device 800. The path 625 may be the same or different connection through which the signal initially generated was communicated to the network 620.

The test signal is placed on output 55 of mixer₁ 50 and the local oscillator signal is placed on the output 65 of mixer₂ 60 as described above. Alternatively, the output 55 of mixer₁ 50 can act as the local oscillator and the output 65 of mixer₂ 60 can act as the test signal. The test signal passes through the network 620, returns to the device 800, and is fed into mixer₃ 640. In this case, mixer₃ 640 is contained within the same physical device 800 as mixer₁ 50, mixer₂ 60, synthesizers 10, 20, and 30, and master clock 40.

The local oscillator signal passes directly from mixer₂ 60 to mixer₃ 640 while remaining within device 800. Mixer₃ 640 then combines the test and local oscillator signals in the standard manner. As described above, the output 645 of the mixer₃ 640 is fed into and analyzed by the signal analyzer 650, which is in the same physical device 800 as mixer₃ 640.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems, and methods described and illustrated in the various embodiments as discrete or separate may be combined or integrated with other systems, modules, techniques, or methods without departing from the scope of the present disclosure. Other items shown as directly coupled or communicating with each other may be coupled through some interface or device, such that the items may no longer be considered directly coupled to each but may still be indirectly coupled and in communication with one another. Other examples of changes, substitutions, and alterations are ascertainable by one skilled in the art and could be made without departing from the spirit and scope disclosed herein.

What we claim as our invention is:

1. A system for generating two signals whose frequencies remain a desired difference from each other while the frequencies for both of the electromagnetic signals vary through multiple ranges of output frequencies, comprising:
a first tunable synthesizer that produces variable signals varied through a range of frequencies to produce a first set of variable signals;
a second tunable synthesizer that produces a first fixed signal having a first frequency;
a third tunable synthesizer that produces a second fixed signal having a second frequency, the second frequency of the second fixed signal differs from the first frequency of the first fixed signal by an amount equal to the desired difference in frequency between the two sets of output signals;
a first mixer operable to receive the first set of variable signals from the first tunable synthesizer and the first fixed signal from the second tunable synthesizer, the first mixer further operable to combine the first fixed signal with each variable signal of the first set of variable signals to generate a first set of output signals having a first range of output frequencies; and
a second mixer operable to receive the first set of variable signals from the first tunable synthesizer and the second fixed signal from the third tunable synthesizer, the first mixer further operable to combine the second fixed signal with each variable signal of the first set of variable signals to generate a second set of output signals having a second range of output frequencies, the first and second range of output frequencies differing by the desired difference.

2. The system of claim 1, wherein the second tunable synthesizer tunable to produce a third fixed signal and the third tunable synthesizer is tunable to produce a fourth fixed signal and wherein the third fixed signal is combined in the first mixer with each variable signal of the first set of variable signals and the fourth fixed synthesizer signal is combined in the second mixer with each variable signal of the first set of variable signals, such that the first mixer generates a second range of output frequencies for the first set of output signals that is approximately contiguous with the first range of output frequencies for the first set of output signals, and further such that the second mixer generates a second range of output frequencies for the second set of output signals that is approximately contiguous with the first range of output frequencies for the second set of output signals.

3. The system of claim 2, wherein the first tunable synthesizer to operable to perform frequency division to produce variable signals varied through a second range of frequencies combined in the first mixer with a fifth fixed synthesizer signal from the second tunable synthesizer to generate the first set of output signals having a third range of output frequencies that are approximately contiguous with the second range of output frequencies of the first set of output signals, and wherein the second range of frequencies is combined in the second mixer with the a sixth fixed signal from the third tunable synthesizer to generate a third range of output frequencies for the second set of output signals that is approximately contiguous with the second range of output frequencies for the second set of output signals.

4. The system of claim 3, wherein further adjustments are made to the frequencies of the signals produced by the first, second, and third synthesizers to generate additional ranges of output frequencies that are approximately contiguous with previously generated ranges of output frequencies.

5. The system of claim 1, further comprising a clock coupled to communicate with the first, second, and third tunable synthesizers.

6. A device for testing the cabling of a computing network, comprising:
a first mixer that injects a set of test signals having varied frequencies into the cabling of the network;
a second mixer that produces a set of local oscillator signals each of which differs by a constant amount in frequency from the frequency of an associated one of the set of test signals;
a first synthesizer that directs a set of signals with a range of frequencies into the first mixer and the second mixer;
a second synthesizer that directs a signal having a fixed frequency into the first mixer, the signal from the second synthesizer and the set of signals from the first synthesizer superimposed in the first mixer to produce the set of test signals; and
a third synthesizer that directs a signal having a fixed frequency into the second mixer, the signal from the third synthesizer and the set of signals from the first synthesizer superimposed in the second mixer to produce the set of local oscillator signals, wherein the fixed frequency of the signal from the third synthesizer differs by the constant amount from the fixed frequency of the signal from the second synthesizer.

7. The device of claim 6, wherein a second set of test signals and a second set of local oscillator signals are operably produced by adjusting the frequency of the signal from the second synthesizer for communication to the first mixer and by adjusting the frequency of the signal from the third synthesizer by the same amount for communication to the second mixer while continuing to provide the set of signals with the range of frequencies into the first mixer and the second mixers.

8. The device of claim 7, wherein the second set of test signals and second set of local oscillator signals are further produced by adjusting the range of the frequencies of the signals that are directed from the first synthesizer into the second and third mixers.

9. The device of claim 8, wherein the first and second sets of test signals are substantially contiguous with one another and wherein the first and second sets of local oscillator signals are substantially contiguous with one another.

10. The device of claim 9, wherein the difference between the frequency of the signal from the second synthesizer and the frequency of the signal from the third synthesizer is equal to an intermediate frequency that is used in the analysis of the cabling of the network.

11. The device of claim 9, wherein the difference between the frequency of the signal from the second synthesizer and the frequency of the signal from the third synthesizer is about 450 kHz.

12. The device of claim 6, further comprising:
a third mixer operable to receive at least a portion of the set of test signals injected to test the cabling of the network and further operable to receive at least a portion of the set of local oscillator signals, the third mixer operable to superimpose the portion of the test signal and the portion of the local oscillator signal and produce a superimposed output signal; and
a signal analyzer that receives and analyzes the superimposed output signal.

13. The device of claim 6, further comprising a clock operably communicating with the first, second, and third synthesizers.

14. A method for generating electromagnetic signals with multiple ranges of frequencies, comprising:
varying a frequency of a signal from a first synthesizer through a range of frequencies;
setting a frequency of a signal from a second tunable synthesizer;
setting a frequency of a signal from a third tunable synthesizer, the frequencies of the signals of the first and second tunable synthesizers set a distance apart;
directing the signals from the first synthesizer and second tunable synthesizer into a first mixer where the signals are combined to generate a first range of output signals whose frequencies are the differences in the frequencies of the signals from the first synthesizer and second tunable synthesizer;
directing the signals from the first synthesizer and third tunable synthesizer into a second mixer where the signals are combined to generate second range of output signals whose frequencies are the differences in the frequencies of the signals from the first synthesizer and third tunable synthesizer, the frequencies of each corresponding signal of first and second range of output signals are provided the distance apart; and
resetting the frequency of the signal from the second tunable synthesizer so that when the signal from the first synthesizer having the frequency range is provided to be combined in the first mixer with the signal from the second tunable synthesizer, a third range of signals is generated whose frequencies are approximately contiguous with the frequencies of the signals in the first range of output signals.

15. The method of claim 14, further comprising resetting the frequency of the signal from the third tunable synthesizer so that when the signal from the first synthesizer having the frequency range is provided to be combined in the first mixer with the signal from the third tunable synthesizer, a fourth range of signals is generated whose frequencies are approximately contiguous with the frequencies of the signals in the second range of output signals.

16. The method of claim 15, wherein the frequencies of each corresponding signal of third and fourth range of output signals are provided the distance apart.

17. The method of claim 14, further comprising directing, by a network test device, at least a portion of the first range of output signals to a network to test cabling of the network.

18. The method of claim 17, wherein the network is further defined as a local area network.

19. The method of claim 14, further comprising directing, by a network test device, the first and second range of output signals to a network to test the network.

20. The method of claim 14, further comprising performing frequency division on the signal produced by the first synthesizer so that the frequencies of the signal produced by the first synthesizer vary through a second range of frequencies.

21. The method of claim 20, further comprising setting the frequency of the signal from the second synthesizer to generate, via the first mixer, a fourth range of output signals whose frequencies are approximately contiguous with the frequencies of the signals in the second range of output signals.
